(19) United States
(12) Patent Application Publication
(10) Pub. No.: US 2005/0153139 A1
(43) Pub. Date: Jul. 14, 2005

(54) Aqueous polyurethane coating system containing zinc crosslinked acrylic dispersion

(76) Inventors: Mark D. Levitt, Saint Paul, MN (US); Minyu Li, Oakdale, MN (US); Lauren K. Carlson, Saint Paul, MN (US); Robert D.P. Hei, Baldwin, WI (US)

Correspondence Address: IPLM GROUP, P.A., POST OFFICE BOX 18455, MINNEAPOLIS, MN, 55418, US

(21) Appl. No.: 10/755,972

(22) Filed: Jan. 12, 2004

(51) Int. Cl. C08G 18/00

(52) U.S. Cl. 428/423.1; 528/44

(57) ABSTRACT

Zinc crosslinked acrylic dispersions can initiate hardening of 2K polyurethane coatings based on polyester polyols or polyurethane polyols and decrease the coating tack-free time. The decreased tack-free times facilitate earlier application of additional polyurethane layers and earlier return of a coated article to service, and can provide improved floor finishes.

### TECHNICAL FIELD

This invention relates to hardenable polyurethane coatings, to methods for applying polyurethane coatings and to polyurethane coated articles.

### BACKGROUND

Polyurethane coatings are widely used for applications in which a protective overcoat or film is desired. For example, two-component or so-called “2K” polyurethanes containing a polyol or polyamine first component and a polyisocyanate second component will react when mixed to form a durable film containing polyurethane or polyurea linkages. Unfortunately, 2K polyurethane coatings can have lengthy drying times. If uncatalyzed, the coating can take hours to become tack-free and days to harden completely. The hardening rate can be accelerated by adding a suitable catalyst or initiator. Although a variety of materials have been suggested for use as initiators, nowadays polyurethane coatings typically are hardened using an organometallic compound such as dibutyltin dilaurate, e.g. as in U.S. Pat. No. 6,316,535 B1.

U.S. Pat. Nos. 3,347,804 and 4,256,848 disclose that zinc salts when used alone are very poor catalysts for polyurethane reactions. These patents (and U.S. Pat. Nos. 4,223,098 and 5,011,902) describe mixed catalyst systems containing a zinc salt of C₂ and higher (e.g., C₂₋₂₀, C₂₋₂₁ or C₂₋₂₂) carboxylic acids together with one or more other metal compounds. U.S. Pat. No. 5,156,915 describes a mixed catalyst system for polyurethanes based on certain ionizable zinc halide salts and bismuth-containing organometallic catalysts. Other zinc-containing catalysts for polyurethanes include those described in U.S. Pat. No. 4,478,959.

U.S. Pat. Nos. 4,517,330 and 5,319,018 describe acid-functional polymers reacted with transition metal compounds including certain zinc compounds. U.S. Pat. No. 5,610,232 describes an adhesive containing a carboxylate functional polyurethane whose isocyanate groups are reacted with water to carry out chain extension. The resulting carboxylate functional prepolymer is crosslinked via its carboxylate groups using zinc ammonium carbonate. U.S. Pat. No. 5,912,298 describes waterborne acid-functional polyurethane resins crosslinked via their acid groups using calcium compounds, and in a comparison example using zinc ammonium carbonate.

### SUMMARY OF THE INVENTION

Due to their relatively long tack-free times, multiple-component polyurethane coatings can be difficult to apply to flooring. Following application of the polyurethane coating, the floor cannot be put into service until the hardening process has advanced sufficiently so that the floor can withstand foot traffic. Sometimes it is necessary to apply more than one layer of polyurethane coating in order to obtain sufficient film thickness and durability. In such cases the polyurethane coating cannot be recoated until the hardening process has advanced sufficiently so that the floor can be walked upon to apply the second or subsequent layers. While hardening of the various layers takes place, the floor is out of service and the finish is susceptible to damage. Catalysts such as dibutyltin dilaurate can sometimes be employed to reduce coating tack-free times, but this may also undesirably increase cost owing to dibutyltin dilaurate's relatively high price.

We have found that the autohardenable reaction product of an acid-functional acrylic polymer and a zinc compound can be used to initiate rapid hardening of 2K polyurethanes based on polyester polyols or polyurethane polyols. The recited reaction products can be referred to as “zinc crosslinked acrylic dispersions”, and are available at relatively low cost in the form of commercial waterborne acrylic floor finish compositions. When a suitable amount of the zinc crosslinked acrylic dispersion is present during hardening of a 2K polyurethane coating based on polyester polyols, polyurethane polyols or a combination thereof, the zinc compound can initiate or accelerate hardening of the 2K polyurethane, and reduce the 2K polyurethane tack-free time without unduly shortening its pot life. The acrylic polymer may also promote early film formation and improved durability while the 2K polyurethane hardening reaction takes place. Zinc crosslinked acrylic dispersions appear to be capable of initiating or accelerating hardening of such 2K polyurethane coatings even if present only in an adjacent non-polyurethane-containing layer.

The present invention provides in one aspect an autohardenable polyurethane coating comprising a polyester polyol or polyurethane polyol and sufficient zinc crosslinked acrylic dispersion to decrease the coating tack-free time.

In another aspect the invention provides a method for applying a polyurethane finish comprising applying to a substrate a layer of an autohardenable polyurethane coating comprising a polyester polyol or polyurethane polyol and sufficient zinc crosslinked acrylic dispersion to decrease the coating tack-free time.

The invention also provides a jobsite-renewable floor finish kit comprising a substantially isocyanate-free undercoat, an autohardenable polyurethane topcoat comprising a polyester polyol or polyurethane polyol, and instructions for jobsite application of the undercoat to a floor and the topcoat to the undercoat, wherein the undercoat or topcoat contain sufficient zinc crosslinked acrylic dispersion to decrease the topcoat tack-free time.

The invention provides in another aspect a method for applying a jobsite-renewable finish to a floor comprising applying to the floor a multilayer coating system comprising a layer or layers of a substantially isocyanate-free undercoat and a layer or layers of an autohardenable polyurethane topcoat comprising a polyester polyol or polyurethane polyol, wherein the undercoat or topcoat contain sufficient zinc crosslinked acrylic dispersion to decrease the topcoat tack-free time.

### DETAILED DESCRIPTION

By using words of orientation such as “atop”, “beneath”, “on”, “under”, “uppermost”, “lowermost”, “between” and the like for the location of various layers in the disclosed multilayer coating system, we refer to the relative position of one or more layers with respect one another or where the context requires with respect to an underlying flooring substrate. We do not intend that the layers or flooring substrate must be horizontal, do not intend that the layers and flooring substrate must be contiguous or continuous, and do not exclude the presence of one or more intervening layers between layers or between the flooring substrate and a layer.

As used in connection with this disclosure, a “multilayer coating system” is a coating system that employs an undercoat and a topcoat of different compositions. In the interest of brevity, a layer or plurality of layers of the undercoat composition located between the flooring substrate and a topcoat may be referred to collectively as an “undercoat”, a layer or plurality of layers of the topcoat composition located atop the flooring substrate and undercoat may be referred to collectively as the “topcoat”, and a combination of a cured undercoat and topcoat (or a topcoat alone) located atop a flooring substrate may be referred to as a “coating” or “finish”.

As used in connection with this disclosure, a “film-former” is a monomer, oligomer or polymer that can be applied (if need be, with a suitable plasticizer or coalescing solvent) and dried, crosslinked or otherwise hardened to form a tack-free substantially durable film.

As used in connection with this disclosure, a “hardening system” is a chemical or physical process (including solvent evaporation or other drying processes, photochemical reactions, electrochemical reactions, radical processes, ionic processes, moisture cure processes and multiple-component (e.g., two or three component) crosslinking processes) through which an undercoat or topcoat composition becomes dried, crosslinked or otherwise cured to form a tack-free substantially durable film.

As used in connection with this disclosure, an “initiator” is an agent that can cause undercoat or topcoat hardening or accelerate the rate at which undercoat or topcoat hardening occurs. We include among initiators materials such as catalysts (including energy activated catalysts, photocatalysts or photoinitiators and thermal catalysts), Lewis and Bronsted acids and bases, radical sources, metal compounds and the like.

As used in connection with this disclosure, an “autohardenable” polyurethane is a coating that contains a polyol and a polyisocyanate, and which begins hardening upon being mixed or dispensed and without requiring an external energy source such as UV or visible light illumination or elevated heating to harden to at least a tack-free state when in a thin film form. We include among autohardenable polyurethanes those having multi-part (e.g., two-part) formulations with two or more separately packaged polyurethane precursors (typically a polyol first component and a polyisocyanate second component) that will harden shortly after the precursors are mixed and applied to a flooring substrate. We also include among autohardenable polyurethanes those whose precursors are packaged in a single container having one or more septa or other suitable dividers that can prevent the precursors from mixing until desired by a user. We also include among autohardenable polyurethanes those containing an encapsulated ingredient that will cause hardening of the polyurethane when the precursors are mixed, dispensed or otherwise processed in a way that causes the microcapsules to rupture.

As used in connection with this disclosure, “pot life” is the time period after an autohardenable polyurethane is dispensed from its container (and if need be, its precursors mixed, dispensed or otherwise processed to initiate hardening) during which the dispensed material can successfully be applied to a flooring substrate to form a thin, visibly smooth, self-leveling, cured film whose properties are generally similar to those exhibited by the polyurethane if applied immediately after being dispensed.

As used in connection with this disclosure, a polyurethane is regarded as being “stripper-permeable” if when coated atop a desired flooring substrate (and optional intervening undercoat) and subjected to the action of a suitable chemical stripper, the stripper permeates or otherwise penetrates the polyurethane sufficiently so that the polyurethane (and undercoat, if present) can be removed from the floor. Stripper permeability can sometimes be enhanced by mechanically roughening, puncturing or abrading the polyurethane (using, for example, a nonwoven floor scrub pad, brush or other mild abrasive measure) just prior to stripping. A polyurethane will be regarded as being stripper-permeable even if such mechanical roughening is necessary for stripping, so long as such mechanical roughening does not unduly damage the underlying floor.

As used in connection with this disclosure, a hardened coating is regarded as being “jobsite-renewable” if, at such time as it may be desired to do so, the coating can be removed from an underlying flooring substrate without removing substantial portions of the flooring substrate, using simple, minimally abrasive measures such as a methylene chloride-free or acetone-free chemical stripper and a mop and detergent solution, mildly abrasive but flooring-safe measures such as a nonwoven floor scrub pad, or other measures such as peeling (and without requiring aggressive removal techniques such as grinding, sanding, sandblasting or a stripper based on methylene chloride or acetone), and then replaced with the same or a substantially similar finish and hardened to provide a visibly smooth tack-free substantially durable film.

As used in connection with this disclosure, an “oligomer” is a polymerizable (e.g., crosslinkable) moiety containing a plurality (e.g., 2 to about 30) of monomer units.

A variety of zinc crosslinked acrylic dispersions can be employed in the invention. Representative zinc crosslinked acrylic dispersions contain an acid-functional acrylic film former and a zinc compound capable of crosslinking the acrylic film former, and include those described in U.S. Pat. Nos. 4,517,330, 5,319,018, 5,869,569 and 6,410,634. Acrylic film formers that can be combined with a zinc compound to form a zinc crosslinked acrylic dispersion include those described in U.S. Pat. Nos. 5,541,265 and 6,361,826. Suitable commercially available zinc crosslinked acrylic coating compositions include PADLOCK™, GEMSTAR LASER™ and TAJ MAHAL™ acrylic floor finishes from Ecolab Inc.; CORNERSTONE™ and TOPLINE™ acrylic floor finishes from 3M; HIGH NOON™ acrylic finish from Butchers; CITATION™ acrylic finish from Buckeye International, Inc., COMPLETE™, SIGNATURE™ and VECTRA™ acrylic floor finishes from S C Johnson Professional Products; SPLENDOR™, DECADE 90™, PRIME SHINE™ ULTRA and PREMIER™ acrylic finishes and FORTRESS™ urethane acrylic finish from Minuteman, International, Inc.; FLOORSTAR™ Premium 25 floor finish from ServiceMaster, Inc.; UPPER LIMITS™ acrylic finish from Spartan Chemical Co.; and materials such as those described in U.S. Pat. Nos. 4,517,330 and 5,319,018 and the patents cited therein. Zinc-containing polymer emulsions such as DURAPLUS™ 3 zinc crosslinked acrylic dispersion and RHOPLEX™ 1421 zinc crosslinked acrylic dispersion, used as ingredients in some floor finishes and commercially available from Rohm & Haas Co.; MEGATRAN™ 205 zinc crosslinked acrylic dispersion and SYNTRAN™ 1580 zinc crosslinked acrylic dispersion, used as ingredients in some floor finishes and commercially available from Interpolymer Corp.; and MOREGLO™ zinc crosslinked acrylic dispersion, used as an ingredient in some floor finishes and commercially available from Omnova Solutions Inc., may also be employed as a source of the zinc crosslinked acrylic dispersion. Substantially zinc-free acrylic coating compositions that can be combined with a zinc compound to form a zinc crosslinked acrylic dispersion for use in the invention include ADURA™ 50 acrylic polymer dispersion from Air Products and Chemicals, Inc.; TECHNIQUE™ acrylic floor finish from S C Johnson Professional Products; FIRST ROUND™ urethane acrylic finish from Minuteman, International, Inc.; and STAY-CLAD™ 5900 hydroxyl-functional acrylic polymer dispersion from Reichhold, Inc.

Sufficient zinc crosslinked acrylic dispersion should be employed in the polyurethane coating (or in an adjacent layer of a substantially isocyanate-free coating) so that the polyurethane tack-free time decreases. Preferably the tack-free time decreases by at least about 10%, more preferably by at least about 30% and most preferably by at least about 50% compared to a polyurethane coating prepared without any zinc crosslinked acrylic dispersion or other initiator in the coating (or in an adjacent coating) and evaluated using the cotton ball Tack-free Evaluation method described below. If present in the polyurethane, the zinc crosslinked acrylic dispersion concentration preferably is sufficiently low so that the polyurethane has a pot life of at least about 20 minutes, more preferably at least about 30 minutes, and yet more preferably at least about 1 to about 2 hours. As a general numeric guide, when a zinc crosslinked acrylic dispersion is added to the topcoat, it is added to the topcoat's polyol or polyamine precursor (using stirring or other methods that will be apparent to those skilled in the art) rather than to the polyisocyanate precursor in order to discourage premature reaction, and is added at a level of at least about 10 ppm zinc, more preferably at least about 100 ppm zinc based on the total topcoat weight. If added to or present in an adjacent substantially isocyanate-free coating (e.g., an undercoat in the case of a multilayer floor finish composition), the zinc crosslinked acrylic dispersion preferably is added at a level of at least about 1 wt. % zinc based on the total isocyanate-free coating weight. The addition can take place well prior to or at a job site.

A variety of polyurethane precursors can be employed in the invention. The precursors as mixed or dispensed may be solvent-borne, waterborne or 100% solids, and may represent a multipart (e.g., a two component or 2K) composition or a latent one part composition containing a blocked isocyanate. The polyurethane precursors preferably are water-soluble or water-dispersible. Water solubility or water dispersibility can be facilitated in a variety of ways that will be familiar to those skilled in the art, including incorporating appropriate functional groups in the polyurethane precursors, converting one or more of the polyurethane precursors to their salt forms, or adding a suitable cosolvent or surfactant. Preferred polyurethane formulations include as precursors (i) a polyester polyol, polyurethane polyol, or combination thereof and (ii) a polyisocyanate such as an aliphatic or aromatic isocyanate oligomer. Two component waterborne polyurethane formulations are especially preferred. As a general guide, the water concentration preferably is from about 15 to about 85 wt. % based on the polyurethane weight. More preferably, the polyurethane contains about 25 to about 75 wt. % water, and most preferably about 35 to about 70 wt. % water. The polyurethane may also contain a suitable diluent, solvent, plasticizer or cosolvent, at a concentration which may vary depending in part on the other polyurethane ingredients and on the intended application and application conditions. As a general guide, the diluent, solvent, plasticizer or cosolvent concentration preferably is from 0.1 to about 10 wt. % based on the polyurethane solution weight, and more preferably about 1 to about 7 wt.

Representative waterborne polyurethanes based on polyester polyols, polyurethane polyols or a combination thereof are described in U.S. Pat. No. 6,316,535 B1 and in U.S. patent application Publication No. U.S. 2002/0028621 A1. Suitable commercially or experimentally available two-part waterborne polyurethanes include those from suppliers including Air Products and Chemicals, Inc. (e.g., No. AD200C1 polyester polyurethane formulation), Bayer AG (e.g., No. MG98-040 polyester polyurethane formulation) and U.S. Polymers, Inc. (e.g., Nos. 979-1 and 980-3 polyester polyurethane formulations).

The polyurethane can contain a variety of adjuvants to alter its performance or properties before or after application to a floor. Useful adjuvants include hardening retarders (which function as pot life extenders), inorganic particles, organic (e.g., polymeric) particles, flatting agents, surfactants, surface slip modifiers, defoamers, waxes, indicators, UV absorbers, light stabilizers, antioxidants, plasticizers, coalescents and adhesion promoters. The types and amounts of such adjuvants will be apparent to those skilled in the art. The polyurethane may if desired be a pigmented coating or paint. The polyurethane can also contain a lightening agent (described further in Application Serial No. (attorney docket no. 117-P-1840U.S.01) entitled FLOOR FINISH WITH LIGHTENING AGENT, filed even date herewith, the disclosure of which is incorporated herein by reference).

The polyurethane may contain inorganic or organic particles (or both inorganic and organic particles) to enhance its abrasion resistance, scratch resistance, wear resistance or strippability. Preferred inorganic particles are described in copending U.S. patent application Ser. No. 09/657,420 filed Sep. 8, 2000 and entitled SCRATCH-RESISTANT STRIPPABLE FINISH, the disclosure of which is incorporated herein by reference. Representative inorganic particles include silicas such as fumed silicas, stabilized silica sols, silica organosols, silicon dioxide particles, colloidal silicas and spherical silicas; aluminas such as aluminum oxide particles and alumina modified colloidal silica; and glasses such as glass beads and glass microbubbles. Representative organic particles include EXPANCEL™ spherical plastic microspheres, commercially available from Akzo Nobel N.V., HYDROPEL™ QB organic particles and NON-SKID™ modified polypropylene waxes, both commercially available from Shamrock Technologies, Inc. Although the inorganic or organic particles may if desired be obtained in dry powder form, preferably they are employed in aqueous or solvent-based dispersions, as such dispersions are much more easily combined with the polyurethane. The particles can also be surface-modified, e.g., to improve their dispersibility in the polyurethane. In general, solvent-based particle dispersions can easily be combined with waterborne polyurethanes and generally can provide good gloss and good film integrity in the cured coating. However, solvent-based particle dispersions tend to be more expensive than aqueous particle dispersions. When waterborne particle dispersions are combined with waterborne polyurethanes, the resulting coating may have somewhat lower gloss and film integrity. We prefer in such circumstances to combine a waterborne particle dispersion with a suitable dispersing solvent (e.g., alcohols such as methanol, ethanol or isopropyl alcohol) that will dissolve in or be miscible with both water and the polyurethane, and that will help to disperse the particles in the polyurethane. The resulting mixture of waterborne particles and dispersing solvent can be combined with the polyurethane and mixed using a suitable mixing device such as a sonic mixer.

Suitable inorganic and organic particles are available in a wide variety of average particle diameters. Small diameter particles tend to provide better adhesion of the polyurethane to an undercoat layer (if present), but also tend to be more expensive than large diameter particles. Large particles may provide better surface scratch resistance. Preferably, the average particle diameter is about 3 to about 10,000 nanometers, more preferably about 12 to about 7,500 nanometers. In some cases, use of a bimodal mixture of small and large diameter particles can provide a cured finish having an optimal balance of good coating properties, scratch resistance and durability. The polyurethane preferably contains sufficient inorganic or organic (or both inorganic and organic) particles to provide increased scratch resistance compared to a polyurethane that does not contain such particles. If desired, large amounts of inorganic or organic particles can be employed, so long as the other properties of the polyurethane are not unduly harmed by the thickening effect or loss of gloss caused by the particle addition. However, particle additions in relatively small amounts may provide a significant improvement in scratch resistance. Preferably, the polyurethane contains about 1 to about 50 wt. % inorganic or organic particles based on the weight of polymerizable solids in the polyurethane. More preferably, the polyurethane contains about 1 to about 25 wt. % inorganic or organic particles, and most preferably about 1 to about 10 wt. % inorganic or organic particles.

A variety of undercoat compositions can be employed in multilayer polyurethane compositions applied to flooring substrates. Preferred undercoats are film-formers that will adhere to the floor, provide an adherent surface for the polyurethane, and be removable using stripping or peeling. Most preferably the undercoat will be strippable using a chemical stripper that is capable of permeating, dissolving, swelling or otherwise softening the polyurethane sufficiently so that the agent can act upon the undercoat. Thus the choice of undercoat may be determined in part by the chosen polyurethane and stripper. The undercoat desirably should be more strippable than the polyurethane. The undercoat can be solvent-borne, waterborne or 100% solids, and can employ a variety of hardening systems. The above-described zinc crosslinked acrylic dispersions are a particularly preferred class of undercoats. Other film-forming materials such as zinc-free acrylic finishes (e.g., acrylic copolymers), water-based (e.g., waterborne) latex emulsions, polyvinyl acetate copolymers (e.g., polyvinyl acetate-polyethylene copolymers), polyvinyl alcohol and its copolymers, polyvinylpyrrolidone and its copolymers, modified cellulose, sulfonated polystyrenes and a variety of other materials that will be familiar to those skilled in the art (e.g., film forming water-soluble or water-dispersible polymers other than those already mentioned) can also be employed as undercoats. Preferred undercoat compositions are also described in Application Serial No. (attorney docket no. 117-P-1805U.S.01) entitled JOBSITE-RENEWABLE MULTILAYER FLOOR FINISH WITH ENHANCED HARDENING RATE, filed even date herewith, the disclosure of which is incorporated herein by reference. The undercoat can if desired be applied in several layers containing different materials in each layer. The individual layers need not be homogeneous. For example, the zinc crosslinked acrylic dispersion may if desired “bloom” to the surface of the hardened undercoat.

The undercoat may if desired contain other initiators for the polyurethane hardening system in place of or in addition to the zinc crosslinked acrylic dispersion. For brevity the zinc crosslinked acrylic dispersion and other such initiators can be collectively referred to as “topcoat initiators”. Preferably the topcoat initiator is not an initiator for the undercoat hardening system. Exemplary topcoat initiators include tin compounds such as dibutyl tin dilaurate, stannous octoate and FASCAT™ 4224 dibutyltin bis(1-thioglycerol) catalyst (commercially available from ATOFINA Chemicals, Inc.); zirconium compounds; amines; and zinc compounds such as ultrafine zinc oxide (described further in Application Serial No. (attorney docket no. 117-P-1833U.S.01) entitled POLYURETHANE COATING CURE ENHANCEMENT USING ULTRAFINE ZINC OXIDE, filed even date herewith, the disclosure of which is incorporated herein by reference) and zinc carbonates including zinc tetraamine carbonate and zinc ammonium carbonate (described further in Application Serial No. (attorney docket no. 117-P-1884U.S.01) entitled POLYURETHANE COATING CURE ENHANCEMENT USING ZINC CARBONATE INITIATORS, filed even date herewith, the disclosure of which is incorporated herein by reference).

The undercoat preferably contains water or another suitable diluent, plasticizer or coalescent, including compounds such as benzyloxyethanol; an ether or hydroxyether such as ethylene glycol phenyl ether (commercially available as “DOWANOL EPh” from Dow Chemical Co.) or propylene glycol phenyl ether (commercially available as “DOWANOL PPh” from Dow Chemical Co.); dibasic esters such as dimethyl adipate, dimethyl succinate, dimethyl glutarate, dimethyl malonate, diethyl adipate, diethyl succinate, diethyl glutarate, dibutyl succinate, and dibutyl glutarate (including products available under the trade designations DBE, DBE-3, DBE-4, DBE-5, DBE-6, DBE-9, DBE-IB, and DBE-ME from DuPont Nylon); dialkyl carbonates such as dimethyl carbonate, diethyl carbonate, dipropyl carbonate, diisopropyl carbonate, and dibutyl carbonate; phthalate esters such as dibutyl phthalate, diethylhexyl phthalate, and diethyl phthalate; and mixtures thereof. Cosolvents can also be added if desired to assist in formulating and applying the undercoat. Suitable cosolvents include Butoxyethyl PROPASOL™, Butyl CARBITOL™ acetate, Butyl CARBITOL™, Butyl CELLOSOLVE™ acetate, Butyl CELLOSOLVE™, Butyl DIPROPASOL™, Butyl PROPASOL™, CARBITOL™ PM-600, CARBITOL™ Low Gravity, CELLOSOLVE™ acetate, CELLOSOLVE™, Ester EEP™, FILMER IBT™, Hexyl CARBITOL™, Hexyl CELLOSOLVE™, Methyl CARBITOL™, Methyl CELLOSOLVE™ acetate, Methyl CELLOSOLVE™, Methyl DIPROPASOL™, Methyl PROPASOL™ acetate, Methyl PROPASOL™, Propyl CARBITOL™, Propyl CELLOSOLVE™, Propyl DIPROPASOL™ and Propyl PROPASOL™, all of which are available from Union Carbide Corp.; and mixtures thereof. The concentration may vary depending in part on the other undercoat ingredients and on the intended application and application conditions. As a general guide, when water alone is used as a diluent, the water concentration preferably is from about 15 to about 98 wt. % based on the undercoat solution weight. More preferably, the undercoat contains about 25 to about 95 wt. % water, and most preferably about 60 to about 95 wt. % water. If a diluent, plasticizer, coalescent or cosolvent other than water is included in the undercoat solution, then its concentration preferably is from about 0.1 to about 10 wt. % based on the weight of polymerizable solids in the undercoat, and more preferably about 1 to about 7 wt. %.

If desired, two or more layers of different undercoats can be employed in order to optimize properties such as adhesion to the floor or to the topcoat, wear resistance, strippability, etc. The undercoat can also contain a variety of adjuvants to alter its performance or properties before or after application to a floor. Useful adjuvants include those mentioned above in connection with the polyurethane.

The polyurethane coatings can be applied to a variety of substrates, including wood, plastics, metals, concrete, wallboard and other mechanical or architectural substrates. The disclosed coatings are particularly well-suited for application to flooring substrates due to their shortened tack-free times. This permits an applicator to walk on the flooring substrate relatively soon after coating application in order to apply additional layers of the composition or to return the floor to service. Representative flooring substrates include resilient substrates such as sheet goods (e.g., vinyl flooring, linoleum or rubber sheeting), vinyl composite tiles, rubber tiles, cork and synthetic sports floors, and non-resilient substrates such as concrete, stone, marble, wood, ceramic tile, grout and Terrazzo. The coating can be jobsite-applied to a flooring substrate after the substrate has been installed (e.g., to monolithic flooring substrates such as sheet vinyl goods, linoleum, cork, rubber sheeting, synthetic sports floors, concrete, stone, marble, grout or Terrazzo, or to multipiece flooring substrates such as vinyl composite tiles, rubber tiles, wood floorboards or ceramic tiles), or can be factory-applied to a flooring substrate before it is installed (e.g., to monolithic flooring substrates such as sheet vinyl goods in roll form, or multipiece flooring substrates such as vinyl composite tiles or wood floorboards). Jobsite application is especially preferred, with suitable jobsites including indoor and outdoor sites involving new or existing residential, commercial and government- or agency-owned facilities.

The polyurethane coatings can be applied using a variety of methods, including spraying, brushing, flat or string mopping, roll coating and flood coating. Mop application, especially flat mopping, is preferred for coating most floors. Suitable mops include those described in U.S. Pat. Nos. 5,315,734, 5,390,390, 5,680,667 and 5,887,311. Typically, the floor should first be cleaned and any loose debris removed. One or more undercoat layers or coats (diluted if necessary with water or another suitable diluent or cosolvent) may be applied to the floor. One to three undercoat layers typically will be preferred. When multiple undercoat layers are employed they can be the same or different. Each undercoat layer preferably will have a dry coating thickness of about 2.5 to about 25 μm, more preferably about 2.5 to about 15 μm. Preferably the overall undercoat dry coating thickness will be about 5 to about 100 μm, and more preferably about 5 to about 50 μm.

After the undercoat has hardened sufficiently so that its visual and physical properties have developed and it is safe to apply a polyurethane layer (or if no undercoat is employed, after the cleaned floor has dried), the polyurethane can be applied. The degree of undercoat hardening that will be deemed sufficient for such polyurethane application and the associated waiting period will usually vary depending on factors such as the undercoat and polyurethane formulations, undercoat coating thickness, ambient conditions and polyurethane coating method, and typically may involve a wait of about 15 minutes to about one hour before polyurethane application. Full hardening of the undercoat may not be needed before the polyurethane can safely be applied. In many instances safe application of the polyurethane will be possible once it is possible to walk on the undercoat without marring it.

One or more (e.g., one to three) polyurethane layers may be applied to the floor or to the undercoat layers. The polyurethane layers preferably are applied before the polyurethane pot life elapses. The presence of an initiator for the polyurethane in the undercoat appears primarily to affect the tack-free time for the first polyurethane layer. If the first polyurethane layer is allowed to harden sufficiently so that it can be walked upon, then the tack-free time for subsequent polyurethane layers may not be greatly influenced by the presence of the initiator in the undercoat. However, if such subsequent polyurethane layers are applied before the first polyurethane layer reaches a walk-on state then some reduction in tack-free time may be observed in the subsequent layers, but to a lesser extent than for the first polyurethane layer. The undercoat may be formulated with a view to promoting the efficacy of the initiator in reducing polyurethane tack-free times. The polyurethane usually is formulated with a view to attaining high durability, a factor that may reduce the efficacy of the initiator with respect to such subsequent polyurethane layers. Each polyurethane layer preferably will have a dry coating thickness of about 2.5 to about 200 μm, more preferably about 2.5 to about 100 μm. Preferably the overall polyurethane dry coating thickness will be relatively thin in order to reduce raw material costs, e.g., about 5 to about 150 μm, and more preferably about 5 to about 40 μm. Multilayer finishes preferably will have an overall dry coating thickness of about 10 to about 500 μm, and more preferably about 10 to about 80 μm.

The floor can be placed into service (or returned to service) once the finish has hardened sufficiently to support normal traffic without marring. Inclusion of the zinc crosslinked acrylic dispersion in the 2K polyurethane topcoat (or if used, in the undercoat) promotes faster topcoat cure and enables the floor to be subjected to normal traffic much earlier than if the initiator is not employed.

The finish can receive normal maintenance until such time as it is desired to remove and renew it. Removal can be carried out, for example, by cleaning the floor (using e.g., a brush or mop) followed by application of a stripper. The chosen stripper may depend in part on the chosen undercoat and polyurethane. Preferred strippers include compositions containing phenyl alcohols (e.g., benzyl alcohol); alkoxy ethers (e.g., glycol ethers such as propylene glycol methyl ether and ETHYL CARBITOL™, BUTYL CARBITOL™ and BUTYL CELLOSOLVE™ solvents from Union Carbide Corp.); alkoxy esters; aryloxy alcohols (e.g., phenoxy ethanol and phenoxy propanol); dibasic esters; N-alkyl pyrrolidones, ketones, esters, metasilicates; amines (e.g., ethanolamine); alkanolamines (e.g., monoethanolamine); acid based agents and caustic agents (e.g., sodium or potassium hydroxide). Strippers containing phenyl alcohols are especially preferred for stripping multilayer finishes employing polyurethane topcoats owing to the relatively high rate at which phenyl alcohols may penetrate such topcoats and their ease of use and low odor. A particularly preferred stripper concentrate contains a polar solvent that is denser than water and a sufficiently low level of cosolvent or surfactant so that upon mixing with water a pseudo-stable aqueous dispersion forms which will phase-separate following application to a surface. Concentrates of this type are described in U.S. Pat. No. 6,544,942. Another preferred stripper concentrate contains about 1 to 75 wt. percent of an ether alcohol solvent having a solubility in water of less than about 5 wt. % of the solvent, and about 1 to 75 wt. % of an ether alcohol solvent/coupler having a solubility in water of about 20 to about 100 wt. % of the solvent/coupler, wherein the vapor pressure of the concentrate is less than 1 millimeter Hg. Concentrates of this type are described in U.S. Pat. No. 6,583,101. The stripper can contain a variety of adjuvants to alter the performance or properties of the stripper before or after application to a cured polyurethane finish. Useful adjuvants include abrasive particles, surfactants, defoamers, indicators, slip reducing agents, colorants and disinfectants. The types and amounts of such adjuvants will be apparent to those skilled in the art.

The stripper should be allowed to stand for a suitable time (e.g., for a minute or more, preferably for two hours or less, and most preferably for between about 5 minutes and about 1 hour) while it softens the finish. After the finish softens sufficiently it can be removed using a variety of techniques including scrubbing, vacuuming, mopping, use of a squeegee, scraping, sweeping, wiping, mild abrasion or other measures that do not remove substantial portions of the floor. Removal will usually be made easier if water or a suitable detergent solution is applied to the softened finish. The floor can be allowed to dry and new layers of the undercoat and polyurethane applied to renew the finish.

Multilayer finishes typically will be sold in the form of a kit including the undercoat and polyurethane in suitable containers or dispensers together with suitable instructions for mixing or dispensing any undercoat and polyurethane components as needed and for applying the undercoat atop a floor and applying the polyurethane atop the undercoat. If desired, the undercoat or polyurethane could be packaged as concentrates intended to be mixed with water or another suitable solvent prior to application. Optionally the kit may include a stripper concentrate in a suitable container. The stripper concentrate typically will be mixed with water or another suitable carrier at, for example, about 5-30% by weight active ingredients prior to application. The kit can also contain additional undercoat materials (e.g., leveling coatings) that can be applied to the floor before application of the undercoat and polyurethane, or various additional materials (e.g., maintenance coats or wax finishes) that can be applied atop the polyurethane. Maintenance coats typically will be applied when the initially-applied multilayer coating exhibits noticeable wear or loss of gloss, and typically will be applied at solids levels that are the same as or somewhat less than the solids levels of the initially-applied polyurethane.

If desired, the multilayer floor finishes can also be factory-applied to a variety of flooring substrates. For example, when factory-applied to a multipiece flooring material, the pieces typically will be coated on at least the top surface and optionally coated or partially coated on the side or bottom surfaces.

The invention is further illustrated in the following non-limiting examples, in which all parts and percentages are by weight (wt.) unless otherwise indicated.

### Tile Preparation

Industrial black and white 305 mm×305 mm vinyl composition tiles (commercially available from the Congoleum Corporation) were used in all examples. Before use, the tile surfaces were cleaned and roughened until no longer shiny, by rubbing with MAGICSCRUB™ mild abrasive cleaner (commercially available from Ecolab Inc.) using a non-woven SCOTCH-BRITE™ green abrasive scrub pad (commercially available from 3M Company). The cleaned tiles were rinsed with tap water and dried at room temperature. This removed all factory applied coatings and surface soil, and provided a consistently reproducible surface.

### Undercoat Formulation and Coating Method

PREMIUM 25™ acrylic polymer-based floor finish (commercially available from Aramark Corporation and identified below as Undercoat No. 1) was employed as an undercoat. The tiles were coated by applying a weighted undercoat amount in two layers to the cleaned tile surface using commercially available microfiber pads, at a wet coating rate of about 48 m²/liter. The first and subsequent undercoat layers were allowed to air dry for at least 15 minutes before applying any further undercoat layers. The coated tiles were then allowed to dry overnight.

### Topcoat Formulations and Coating Method

Two-component polyurethane topcoat formulations based on a commercially available polyester polyol resin (BAYHYDROL™ XP-7093, 30% nonvolatiles, Bayer Corporation), and commercially available hexamethylene diisocyanates (DESMODUR™ N-3600 or BAYHYDUR™ XP-7165, both from Bayer Corporation) were prepared as follows. The polyester polyol precursor (designated as Part A in Table 1) was made by mixing the polyol, surfactants and water as set out below. Part A was combined with the isocyanate precursor (designated Part as B in Table 1) according to the weight ratios given in Table 1. The topcoat precursors were mixed vigorously for three minutes, then allowed to sit for 10 to 12 minutes before applying a pre-weighed amount of the topcoat atop the air-dried undercoat using a flocked pad, at a wet coating rate of about 16-18.4 m²/liter. In one instance (Topcoat No. 1), deionized water was stirred into the mixture of Part A and Part B just prior to topcoat application. The topcoated tiles were allowed to dry at room temperature. The dried tiles had a tack-free, glossy finish made from a polyacrylate-based undercoat and a polyurethane-based topcoat.

TABLE 1
Topcoats

| | | Top coat No. | Top coat No. | |
|---|---|---|---|---|
| | | 1 | 2 | |
| | | Parts by | Parts by | Top coat No. 3 |
| | Ingredient | weight | weight | Parts by weight |
| Part A | Polyester polyol⁽¹⁾ | 100 | 88.90 | 54.95 |
| | Silicone | 0.13 | 0.13 | 0.08 |
| | defoamer⁽²⁾ | | | |
| | Wetting agent⁽³⁾ | 0.80 | | |
| | Surface agent⁽⁴⁾ | | 0.06 | 0.04 |
| | Surface agent⁽⁵⁾ | | 1.16 | 0.77 |
| | Deionized water | | 9.75 | 10.09 |
| Part B | Hexamethylene | 21.47 | 39.78 | |
| | diisocyanate⁽⁶⁾ | | | |
| | Hydrophilic | 13.49 | 100 | 23.38 |
| | hexamethylene | | | |
| | diisocyanate⁽⁷⁾ | | | |
| Mix | Part A | 20.68 | 22.5 | 22.15 |
| Ratios | Part B | 7.16 | 7.5 | 7.85 |
| | Deionized water | 2.16 | | |

⁽¹⁾BAYHYDROL ™ XP-7093, 30% nonvolatiles, Bayer Corporation.
⁽²⁾BYK ™ 025, BYK Chemie.
⁽³⁾BYK ™ 346, BYK Chemie.
⁽⁴⁾BYK ™ 348, BYK Chemie.
⁽⁵⁾BYK ™ 380, BYK Chemie.
⁽⁶⁾DESMODUR ™ N-3600, Bayer Corporation.
⁽⁷⁾BAYHYDUR ™ XP-7165, Bayer Corporation.

### Zinc Analysis

Zinc content was determined using inductively coupled plasma (“ICP”) analysis carried out as follows. Approximately 1.0 g of the initiator sample was weighed in a 100 ml beaker and dried in a muffle furnace at 200° C. until no liquid was left. The sample was then ashed at 600° C. overnight, cooled, dissolved in 20 ml nitric acid and heated on a hotplate until approximately 3 ml. of analyte remained in the beaker. The analyte was filtered through a glass fiber filter, diluted to volume with nanopure water in a 50 ml. volumetric flask and analyzed for elemental zinc using a thermo-elemental IRIS simultaneous ICP apparatus (Thermo Electron Corp.).

### Film Evaluation

The coated tiles were evaluated to assess tack-free time, solution pot life, gloss and removability, as follows:

### Tack-free Evaluation

Two methods were used to assess topcoat tack-free time. In Method 1, a finger was used to press a cotton ball or paper towel gently against the topcoat surface at various time intervals following application. The cotton was removed and the presence of any fibers retained by the coating noted. The tack-free time was defined as the interval after which no fibers were retained on the tested coating surface. In Method 2, a small (7.6 mm×7.6 mm) cotton square was placed on the coating surface and covered with a 2 kg weight for 30 seconds. The weight was removed and the cotton lightly brushed or rubbed away using a finger. Any substantially noticeable amount of fibers remaining on the topcoat indicated the topcoat was still tacky and that the tack-free time had not been reached. For either method, coating surfaces that exhibited a shorter tack-free time tended to cure or harden more quickly overall than coatings with longer tack-free times.

### Polvurethane Pot Life Evaluation

Polyurethane pot lives were determined by observing the elapsed time between the start of mixing and the first visual appearance of a precipitate or gel in the polyurethane. The longer it took for precipitation to occur or for a gel to appear, the better the pot life.

### Gloss

Film gloss was measured at 60° and 20° using a Micro-TRI-Gloss meter (commercially available from Paul N. Gardner Co., Inc.). An average of 10 readings was reported. The standard deviation for individual samples was less than 3%.

### EXAMPLE 1

The zinc crosslinked acrylic dispersion present in DURAPLUS 3 acrylic floor finish was evaluated as a topcoat initiator by adding varying amounts of DURAPLUS 3 finish to Topcoat No. 2. The resulting mixtures were applied to vinyl composition tiles cleaned as described above. The polyurethane tack-free times and pot life times were determined as described above. The zinc concentration values shown below in Table 3 were calculated by multiplying the DURAPLUS 3 finish concentration in Topcoat No. 2 by the zinc content (determined using ICP analysis as described above) of 1.4% Zn for undiluted DURAPLUS 3 finish.

TABLE 3

| | ZCD¹ | | | Results | |
|---|---|---|---|---|---|
| | | Wt. % | | Tack-free | |
| Run | | in | Zinc | Time | Topcoat Pot Life |
| No. | Identity | Topcoat | Conc., % | (hours:min) | (hours:min) |
| 1-1 | None | 0 | 0 | 3:56 | 5:30 |
| 1-2 | DP3² | 2.8 | 0.04 | 2:18 | 5:00 |
| 1-3 | DP3 | 4.3 | 0.06 | 1:40 | 4:00 |
| 1-4 | DP3 | 5.9 | 0.08 | 1:21 | 3:30 |

¹Zinc crosslinked acrylic dispersion.
²DURAPLUS 3 aqueous dispersion of zinc cross-linked acrylic copolymer (minimal to no hydroxyl functionality), 38% nonvolatiles, commercially available from Rohm & Haas Co.

The results in Table 3 demonstrate that adding a zinc crosslinked acrylic dispersion to a 2K polyurethane could substantially reduce the polyurethane tack-free time (compare Run Nos. 1-1 and 1-2). As the zinc level increased the pot life was shortened (compare Run Nos. 1-2, 1-3 and 1-4) but remained above 3 hours, a sufficient time period for typical floor applications.

### EXAMPLE 2

Using the method of Example 1, several acrylic dispersions (some of which contained zinc and some of which did not) were added to 18 parts of Part A of Topcoat No. 1 in an amount sufficient to provide 8.5 wt. % acrylic dispersion solids compared to the total solids in the mixture. For acrylic dispersions containing more than 38 wt. % nonvolatile components, additional water was added to Part A to maintain a constant % solids level among the mixtures. For all but the control run (Run No. 2-1, which was mixed as described in the section entitled “Topcoat Formulations and Coating Method”), the acrylic dispersion/Part A mixtures were combined with 7.16 parts of Part B and mixed thoroughly for three minutes. The mixtures were next allowed to stand for about 15 minutes, diluted with 2.16 parts additional water, and then applied to bare cleaned tiles as in Example 1. The acrylic dispersion identities, dispersion and zinc levels, polyurethane tack-free times and pot life times are shown below in Table 4.

TABLE 4

| | Acrylic Dispersion | | | | | |
|---|---|---|---|---|---|---|
| | | Zinc | | Zinc | Results | |
| | | Conc. in | | Conc. in | Tack-free | Topcoat |
| Run | | Dispersion | Wt. % in | Topcoat | Time | Pot Life |
| No. | Identity | (ppm) | Topcoat | (ppm) | (hours:min) | (hours:min) |
| 2-1 | None | 0 | 0 | 0 | >2:00 | >2:30 |
| 2-2 | XK110¹ | ND² | 8.2 | 0 | >2:00 | >2:30 |
| 2-3 | 3275³ | ND | 9.9 | 0 | >2:00 | 2:25 |
| 2-4 | S-C⁴ | <0.576 | 9.1 | <0.05 | >2:00 | >2:30 |
| 2-5 | DP C-3817⁵ | 0.599 | 10.0 | 0.06 | >2:00 | 1:45 |
| 2-6 | A 50⁶ | 0.73 | 9.5 | 0.07 | >2:00 | 2:10 |
| 2-7 | DP 3⁷ | 14100 | 10.0 | 1410 | 1:10 | 1:45 |

¹NEOCRYL XK110 aqueous dispersion of acrylic copolymer with hydroxyl functionality, 46.5% nonvolatiles, commercially available from Avecia.
²Not determined.
³ROSHIELD 3275 aqueous dispersion of acrylic copolymer with hydroxyl functionality, 38.5% nonvolatiles, commercially available from Rohm & Haas Co.
⁴STA-CLAD 5900 aqueous dispersion of acrylic copolymer with hydroxyl functionality, 42% nonvolatiles, commercially available from Reichhold, Inc.
⁵DURAPLUS C-3817 aqueous dispersion of zinc cross-linked acrylic copolymer with hydroxyl functionality, 38% nonvolatiles, commercially available from Rohm & Haas Co.
⁶ADURA 50 aqueous dispersion of acrylic copolymer, 40% nonvolatiles, commercially available from Air Products and Chemicals, Inc.
⁷DURAPLUS 3 aqueous dispersion of zinc cross-linked acrylic copolymer (minimal to no hydroxyl functionality), 38% nonvolatiles, commercially available from Rohm & Haas Co.

The results in Table 4 demonstrate that adding a zinc-free acrylic dispersion to a 2K polyurethane did not reduce the polyurethane tack-free time (compare Run Nos. 2-1, 2-2 and 2-3). Adding a zinc crosslinked acrylic dispersion containing only a low amount of zinc did not shorten the tack-free time but adding dispersions containing higher zinc amounts did do so.

### EXAMPLE 3

A zinc crosslinked acrylic dispersion was added in varying amounts to Undercoat No. 1 and evaluated as a topcoat initiator in a multilayer floor finish system. Two layers of the thus-modified undercoat formulations were applied to cleaned tiles and allowed to dry overnight as described above in the section entitled “Undercoat Formulation and Coating Method”. Next a layer of Topcoat No. 3 was applied to the coated tiles as described above in the section entitled “Topcoat Formulations and Coating Method”. The added zinc crosslinked acrylic dispersion amounts, zinc levels and polyurethane tack-free times are shown below in Table 5.

TABLE 5

| | Added | | |
|---|---|---|---|
| | ZCAD¹ | Zinc Conc. in | Tack-free |
| Run No. | Amount, (%) | Undercoat (%) | Time (hours:min) |
| 3-1 | 0 | ˜0.8 | >7:30 |
| 3-2 | 25 | ˜1.0 | 7:30 |
| 3-3 | 50 | ˜1.1 | 7:30 |
| 3-4 | 100 | ˜1.4 | 4:30 |

¹Added amount of DURAPLUS 3 zinc cross-linked acrylic dispersion (minimal to no hydroxyl functionality), 38% nonvolatiles, commercially available from Rohm & Haas Co.

The results in Table 5 demonstrate that a zinc crosslinked acrylic dispersion could initiate or accelerate hardening in a 2K polyurethane coating based on a polyester polyol even when present only in an adjacent non-polyurethane-containing layer. Low levels of zinc crosslinked acrylic dispersion did not provide a significant reduction in the 2K polyurethane tack-free time (compare Run Nos. 1-1, 1-2 and 1-3), but at levels above about 0.7 wt. % zinc a significant reduction in tack-free time was observed (compare Run Nos. 1-1 and 1-4).

Various modifications and alterations of this invention will be apparent to those skilled in the art without departing from the scope and spirit of this invention. It should be understood that this invention is not limited to the illustrative embodiments set forth above.

1. An autohardenable polyurethane coating comprising a polyester polyol or polyurethane polyol and sufficient zinc crosslinked acrylic dispersion to decrease the coating tack-free time.

2. A coating according to claim 1 containing sufficient zinc crosslinked acrylic dispersion to decrease the coating tack-free time by at least about 10%.

3. A coating according to claim 1 containing sufficient zinc crosslinked acrylic dispersion to decrease the coating tack-free time by at least about 30%.

4. A coating according to claim 1 containing sufficient zinc crosslinked acrylic dispersion to decrease the coating tack-free time by at least about 50%.

5. A coating according to claim 1 containing at least about 10 ppm zinc.

6. A coating according to claim 1 containing at least about 100 ppm zinc.

7. A coating according to claim 1 wherein the coating comprises a polyester polyol.

8. A coating according to claim 1 wherein the coating comprises a polyurethane polyol.

9. A coating according to claim 1 wherein the coating comprises a waterborne multicomponent polyurethane.

10. A method for applying a polyurethane finish comprising applying to a substrate a layer of an autohardenable polyurethane coating comprising a polyester polyol or polyurethane polyol and sufficient zinc crosslinked acrylic dispersion to decrease the coating tack-free time.

11. A method according to claim 10 wherein the coating contains sufficient zinc crosslinked acrylic dispersion to decrease the coating tack-free time by at least about 10%.

12. A method according to claim 10 wherein the coating contains sufficient zinc crosslinked acrylic dispersion to decrease the coating tack-free time by at least about 30%.

13. A method according to claim 10 wherein the coating contains sufficient zinc crosslinked acrylic dispersion to decrease the coating tack-free time by at least about 50%.

14. A method according to claim 10 wherein the coating contains at least about 10 ppm zinc.

15. A method according to claim 10 wherein the coating contains at least about 100 ppm zinc.

16. A method according to claim 10 wherein the coating comprises a polyester polyol.

17. A method according to claim 10 wherein the coating comprises a polyurethane polyol.

18. A method according to claim 10 wherein the coating comprises a waterborne multicomponent polyurethane.

19. A method according to claim 18 further comprising walking on the polyurethane after it has become tack-free to apply a further polyurethane layer or a layer of another film-forming material.

20. A jobsite-renewable floor finish kit comprising a substantially isocyanate-free undercoat, an autohardenable polyurethane topcoat comprising a polyester polyol or polyurethane polyol, and instructions for jobsite application of the undercoat to a floor and the topcoat to the undercoat, wherein the undercoat or topcoat contain sufficient zinc crosslinked acrylic dispersion to decrease the topcoat tack-free time.

21. A kit according to claim 20 containing sufficient zinc crosslinked acrylic dispersion to decrease the polyurethane tack-free time by at least about 10%.

22. A kit according to claim 20 containing sufficient zinc crosslinked acrylic dispersion to decrease the polyurethane tack-free time by at least about 30%.

23. A kit according to claim 20 containing sufficient zinc crosslinked acrylic dispersion to decrease the polyurethane tack-free time by at least about 50%.

24. A kit according to claim 20 wherein the polyurethane contains at least about 10 ppm zinc.

25. A kit according to claim 20 wherein the polyurethane contains at least about 100 ppm zinc.

26. A kit according to claim 20 wherein the undercoat contain at least about 1 wt. % zinc.

28. A kit according to claim 27 wherein the topcoat comprises a polyisocyanate and a polyester polyol.

27. A kit according to claim 20 wherein the topcoat comprises a waterborne multicomponent polyurethane.

29. A kit according to claim 20 further comprising a waterborne maintenance coat composition.

30. A kit according to claim 20 further comprising a stripper.

31. A kit according to claim 20 wherein the hardened polyurethane and undercoat can be removed from the floor by applying a stripper composition containing at least one polar solvent, allowing the stripper composition to contact the polyurethane for sufficient time to soften the polyurethane and undercoat, and removing the softened polyurethane and undercoat without removing substantial portions of the floor.

32. A method for applying a jobsite-renewable finish to a floor comprising applying to the floor a multilayer coating system comprising a layer or layers of a substantially isocyanate-free undercoat and a layer or layers of an autohardenable polyurethane topcoat comprising a polyester polyol or polyurethane polyol, wherein the undercoat or topcoat contain sufficient zinc crosslinked acrylic dispersion to decrease the topcoat tack-free time.

33. A method according to claim 32 wherein the undercoat or topcoat contain sufficient zinc crosslinked acrylic dispersion to decrease the polyurethane tack-free time by at least about 10%.

34. A method according to claim 32 wherein both the undercoat and polyurethane comprise zinc crosslinked acrylic dispersion.

35. A method according to claim 32 wherein the undercoat comprises a zinc crosslinked acrylic dispersion and the topcoat does not.

36. A method according to claim 32 wherein the polyurethane comprises a waterborne multicomponent polyurethane.

37. A method according to claim 36 wherein the polyurethane comprises a polyisocyanate and a polyester polyol.

38. A method according to claim 32 wherein the hardened polyurethane and undercoat can be removed from the floor by applying a stripper composition containing at least one polar solvent, allowing the stripper composition to contact the polyurethane for sufficient time to soften the polyurethane and undercoat, and removing the softened polyurethane and undercoat without removing substantial portions of the floor.

39. A method according to claim 32 wherein the floor comprises wood, vinyl or vinyl composite.

40. A method according to claim 32 further comprising walking on the polyurethane after it has become tack-free to apply a further polyurethane layer or a layer of another film-forming material.
